(19) United States
(12) Patent Application Publication
(10) Pub. No.: US 2001/0054849 A1
(43) Pub. Date: Dec. 27, 2001

(54) ELECTRIC MOTOR

(76) Inventor: TADEUSZ RYBAK, MEDINDIE (AU)

Correspondence Address: THE MAXHAM FIRM, SYMPHONY TOWERS, 750 B STREET, SUITE 3100, SAN DIEGO, CA, 92101, US

(21) Appl. No.: 09/368,894

(22) Filed: Aug. 5, 1999

(51) Int. Cl. H02K 41/00

(52) U.S. Cl. 310/12; 310/216

(57) ABSTRACT

The invention is directed to an electric motor which can be adapted to drive a variety of circularly driven apparatus which can be powered by a single of multi-phase constant frequency alternating current supply but which can provide variable speed by energising one or more discrete or linear electric motors located in an array positioned on the periphery of an annular stator and adjacent a partly annular rotor and therefore obviate the need for geared mechanical coupling of the driven element with the rotor of the electric motor.

This invention relates to asynchronous electric motors and in particular to discrete electric motors used in a circular array and switching control so as to provide control of the speed of the driven element of the motor.

### BACKGROUND

Asynchronous electric motors are typically arranged to provide rotational motion of a rotor which is connected to output shaft which is then mechanically coupled to provide for the rotation of machine elements, eg wheels and the like. The speed of rotation of the wheel is determined by the frequency and/or voltage of the alternating current used to supply energy to the motor. The stator (typically two or more coils of wire located on an electromagnetic material) receives the energy, and the driven part of the motor, the rotor (typically electromagnetic material attached to an axially rotating shaft) provides the motive output of the motor.

Asynchronous electric motors particularly linear electric motors when energised produce linear motion of one part of the motor relative to another part of the motor, referred to as the drive and driven parts. The speed of the relative movement is primarily dependent on the frequency of the alternating current used to supply energy to the drive part of the motor.

Relatively high torque at low speed is not obtained directly from typical asynchronous motors but can be provided by using mechanical gears which complicates the matter since cost and reliability are introduced.

It is an object of the invention to provide an electric motor of simple and compact construction.

It is also an object of the invention to provide an electric motor which can be adapted to drive a variety of circularly driven apparatus which can be powered by a constant frequency alternating current supply but which can provide variable speed by energising one or more discrete or linear electric motors and therefore obviate the need for geared mechanical coupling of the driven element with the rotating part of the circularly driven apparatus.

### SUMMARY OF THE INVENTION

In a broad aspect of the invention an electric motor comprises a frame or housing around an output shaft,

electronically energisable drive means carried by one of the frame or housing and the shaft, and driven means carried by the other of the housing and the shaft, the drive means and driven means having co-operating adjacent faces extending radially of the shaft axis, characterised in that the drive means comprises one or more linear electric motors equally radially spaced from the shaft axis and electrically energised so as to effect relative rotation between the frame or housing and the shaft at a predetermined rotational velocity about the shaft axis in a predetermined direction.

In a further aspect of the invention sets of linear electric motor are electrically energised by a single-phase or a multi-phase alternating electric current so as to effect relative rotation of the frame or housing about the shaft axis at a speed determined by the frequency of said alternating current.

In a further aspect of the invention one or more sets of linear electric motors are each electrically energised by one of a multi-phase alternating electric current so as to effect relative rotation of the frame or housing about the shaft axis at a speed determined by the number of sets of linear electric motors energised by a respective phase of the multi-phase alternating electric current, wherein the frequency of said alternating current is constant.

In yet a further aspect of the invention a first set of two or more adjacent linear electric motors are energised by a first phase of a three-phase alternating electric current; and a second set of two or more linear electric motors adjacent to said first set are energised by a second phase of a three-phase alternating electric current; and a third set of two or more linear electric motors adjacent to said first and second set are energised by a third phase of a three-phase alternating electric current so as to effect relative rotation of the frame or housing about a shaft axis at a speed determined by the number of adjacent linear motors energised by a respective phase of a three-phase alternating electric current wherein the frequency of said alternating current is constant.

For most purposes, the invention can be embodied in a motor having a housing of annular shape with the shaft formed with or attached to the driven means, so as to function as an output or drive shaft. The driven means carried by the shaft preferably comprises an annular ring of electromagnetic or electrically conductive material located on the circumference of a disc upon which, at the radial centre, is located the shaft. The material may be selected to maximise the electromotive force and thus the drive effect of energisation of the drive means. The drive means, preferably comprises a plurality of annular stator windings carried by the housing so that each winding is arranged equally radially spaced from the shaft axis and in a preferable form adjacent each other forming a continuous circumferential array of coils aligned and adjacent to the annularly shaped material of the driven means.

The motor functions as a result of the energisation of sets of one or more adjacent coils by in a preferred arrangement a respective phase of a three-phase alternating current supply. The speed of the motor is controlled by energising an appropriate number of adjacent coils being less than, equal to, or more than a previous number of coils while also energising respective sets of one or more coils equally circumferentially spaced about the annular ring of electromagnetic or electrically conductive material.

The material upon which the stator windings are wound is preferably amorphous magnetic material (AMM) also known as “metallic glass”.

Specific embodiments of the invention will now be described in some further detail with reference to and as illustrated in the accompanying figures. These embodiments are illustrative, and not meant to be restrictive of the scope of the invention. Suggestions and descriptions of other embodiments may be included but they may not be illustrated in the accompanying figures or alternatively features of the invention may be shown in the figures but not described in the specification.

### BRIEF DESCRIPTION OF THE DRAWINGS

The invention is further described below, by way of example, with reference to the accompanying drawings, in which:

FIG. 1a is a schematic side view of an electric motor with a portion of the discrete singular stator windings depicted;

FIG. 1b is a schematic side view of a portion of the discrete singular stator windings and their association with a three-phase alternating current supply;

FIG. 1c is a schematic side view of a portion of the discrete singular stator windings and a different association with a three-phase alternating current supply than that depicted in FIG. 1b;

FIG. 2 is a schematic side view of a continuous circumferential array of adjacently located sets of stator windings;

FIG. 3a is a schematic of the interconnection of discrete singular stator windings to produce a set of coils for energisation by a three-phase alternating current supply;

FIG. 3b is a schematic of an alternative interconnection to that depicted if FIG. 3a;

FIG. 3c is a schematic of a further alternative interconnection to that depicted in FIGS. 3a and 3b;

FIG. 4 is a schematic of a continuous stator core having a plurality of discrete stator windings;

FIG. 5 is a schematic of the slots created in an annulus shaped continuous core for a stator of the invention;

FIG. 6 depicts a side view of a motor of the invention used in a vehicle arranged to drive the rear wheels of the vehicle;

FIG. 7 depicts a top view of one arrangement of the motor of the invention coupled to wheels of a vehicle;

FIG. 8 depicts a side view of a motor of the invention arranged alternatively to that of FIG. 6;

FIG. 9 depicts a section view of a motor of the invention set into a wheel;

FIG. 10 depicts a section view of variation of a motor of the invention set into a wheel;

FIG. 11 depicts an external view of a wheel according to the invention depicted in rigs 9 and 10;

FIG. 12 depicts a section view of a front loading washing machine having a motor according to the invention;

FIG. 13 depicts a flow diagram of the sequence of steps performed by a vehicle according to that schematically depicted in FIGS. 6 and 7;

FIG. 14 depicts a flow diagram of the sequence of steps performed by a speed controller associated with a bicycle using a motorised wheel as depicted in FIGS. 9, 10 and 11; and

FIG. 15 depicts a flow diagram of the sequence of steps performed by a washing machine using a motor and drive arrangement as depicted in FIG. 12.

### DETAILED DESCRIPTION OF EMBODIMENTS OF THE INVENTION

In this invention it is possible for the coils located on an electromagnetic material to be stationary or moving relative to an electromagnetic body which is moving or stationary respectively. However, in the examples provided the coils wound on an electromagnetic former will be referred to as the stator or nominally the stationary part, and the movable electromagnetic body will be referred to as the rotor or nominally the rotating part of the motor.

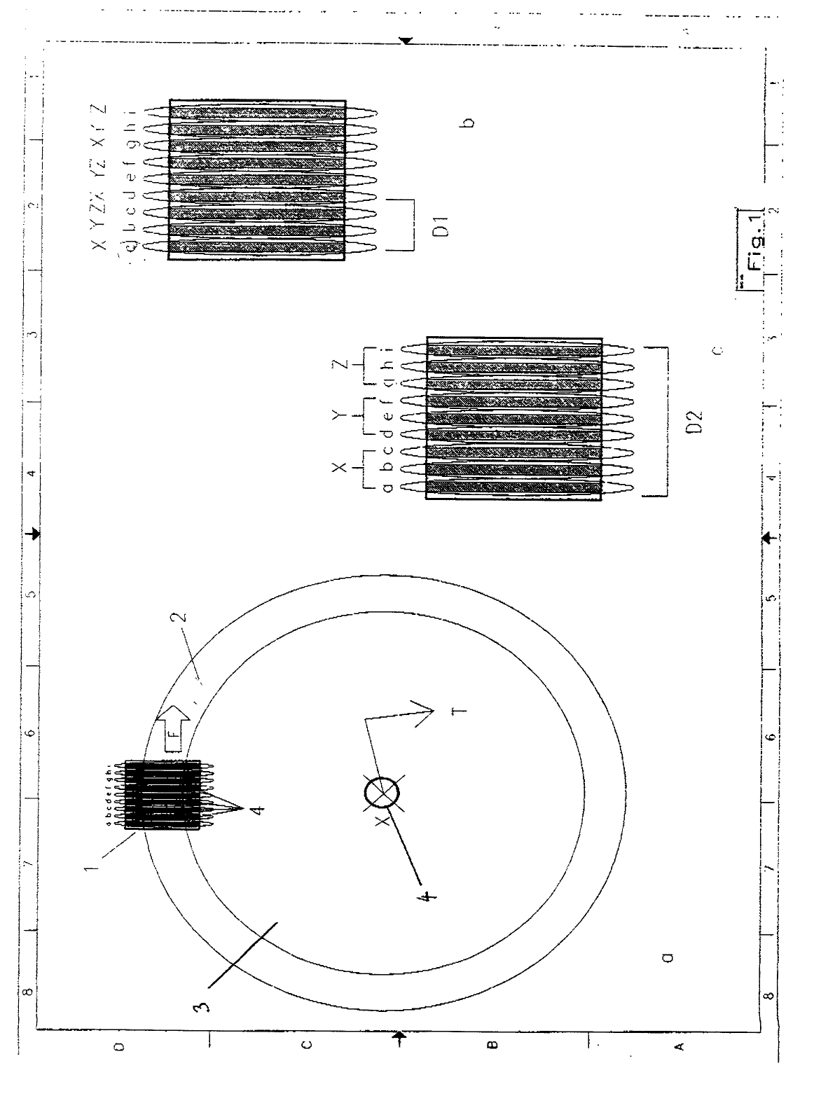

FIG. 1a schematically depicts discrete coils (windings) a, b, c, d, e, f, g, h, i (1) which is merely representative of a set of coils arranged equally spaced from each other and equally radially spaced from a co-axial axis of a proposed ring of coils.

When the coils are appropriately energised they induce a motive force to a continuous annulus of electromagnetic rotor material (2) which is located on the periphery of a disc (3) having a rotation of axis which is co-axial with the axis of the ring of coils (1).

Depending on the desired direction of rotation the rotor can be rotated by the appropriate energisation of successive coils a, b, c, d, e . . . and thus produce a useable torque on the shaft (4) (shown in end view) attached to the axis of the disc.

The annular electromagnetic material (2) can be for example aluminium or copper and it is also possible to supplement the arrangement depicted schematically in FIG. 1a by creating radial slots in the annular material so as to provide circular eddy current paths which can increase the realisable motive force from the electric motor arrangement.

It may also be possible to insert suitably shaped ferromagnetic material in the created slots (some slot shapes may not be suitable), such as AMM, so as to increase the motive force from the electric motor arrangement.

In a further example, individual coil/former units are not physically located adjacent one another to form a ring but a single continuous rotor of circular former is created and appropriate slots are cut into the side of the circular former for the winding of individual coils about the teeth left between the slots. There is an advantage in the latter arrangement since the slots can be accurately cut and thus ensure equal distribution of the coils about the periphery of the stator and magnetic flux distribution is uninterrupted about the periphery of the stator.

It will be understood that the operation of all motors is reliant on the energisation of at least two coils which are in their simplest configuration located diametrically opposed (180°) to each other. The electromotive force imparted by the energisation of the coils are in opposite directions but which have a sum in a particular direction thus setting the rotor into rotation about the shaft axis. If three-phase alternating current is used the respective coils which may be spaced adjacent each other about the axis of rotation will act to also set the rotor into rotation about the shaft axis. In this specification only one of any set of coils operating in the above described manner will be described ie as depicted pictorially in FIG. 1 sets of coils are energised with a respective phase of the multi and in this example 3-phase alternating current.

Using an arrangement of coils as described above it is possible to control the speed of rotation of the rotor relative to the stationary stator by three methods.

Although a single coil is the basic unit of a drive means which is energisable a collection of coils joined together may also perform exactly the same function and an array of such coils along a linear axis can be created, even in a motor which is annular in form, since an array of such linearly adjacent coils can be located on the periphery of a stator either using individual stator material or a common annular stator material. Such an arrangement is referred to herein as a linear motor.

A typical method of speed control when using asynchronous linear electric motors is to vary the frequency of the alternating current, but it is recognised that high frequency is needed to provide high motive forces and thus at high speed varying the frequency may reach a point of diminishing returns, and at too low a frequency there will be too small a motive force to be useful.

Typically also if the frequency of the alternating current is maintained constant so as to provide constant speed, the power output needs of the motor increase, so must the applied voltage.

A second alternative, is to control the voltage of the applied alternating current and thus vary the speed of the motor. Both methods are known and practiced in the art.

However, in the unique electric motor arrangement described above and within this specification it is possible to use both frequency and voltage to vary the rate of rotation of the rotor. However, it is also possible with this arrangement to have a large degree of repeatable control of the rotation rate of the rotor by appropriately switching one or more coils with one or more phases of an alternating current (AC) supply.

It is also possible to use combinations of the abovementioned methods.

In a further embodiment of the arrangement depicted in FIG. 1a the coils a-i are discrete and each is provided a three-phase alternating current supply, thus as depicted in FIG. 1b phase X energised coil a, phase Y energises coil b, and phase Z energises coils c which provides motive force so as to rotate the rotor a distance D1. In the next cycle phase X energises coil d, phase Y energises coil e, and phase Z energises coil f to induce a move of the rotor another distance D1. Thus for a fixed frequency each AC supply cycle will result in the rotor moving a distance D1.

In a variation of the above, as depicted in FIG. 1c, at a constant frequency, each AC supply cycle results in the rotor moving a distance D2 as phase X energises coils a, b, c, phase Y energises coils d, e, f, and phase Z energises coils g, h, i. D2 is three times D1 and the rotational speed advantage for the same frequency of operation is substantially three times as much. Clearly, larger numbers of coil energisations will require higher voltage and current requirements, but the principle of switching into energisation more or less coils is shown to provide control over the rate of rotation of the rotor.

The physical arrangement for switching variable numbers of predetermined sets of coils is not shown since it would be simple for one skilled in the art to design and implement such an arrangement. Ideally, such an arrangement will be configured using fast acting solid state switch devices.

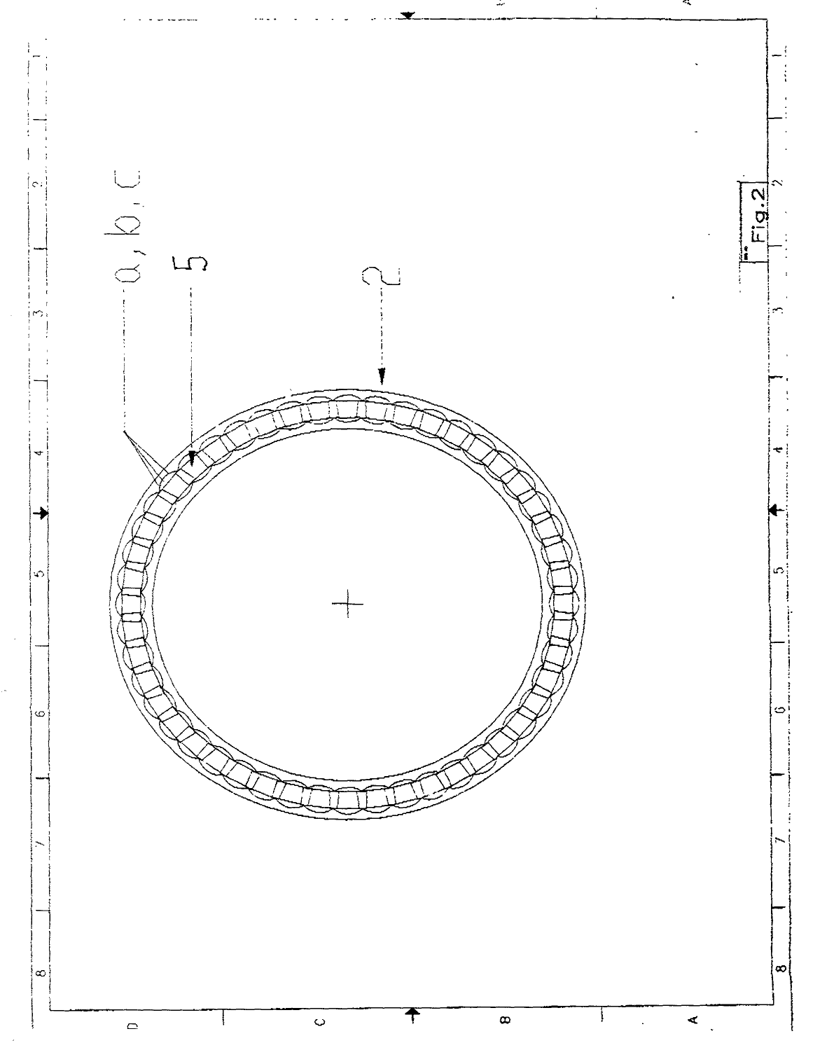

FIG. 2 is illustrative of a plurality of individual stator units (5) each having in this embodiment three coils a, b and c arranged adjacent each other to form a ring shaped stator which is located adjacent an annular electromagnetic material (2). In such an arrangement it is possible to provide the three-phase AC supply in the manner depicted in FIG. 1c so as to induce rotation of the rotor at increments of D2 each cycle of the three-phase AC supply.

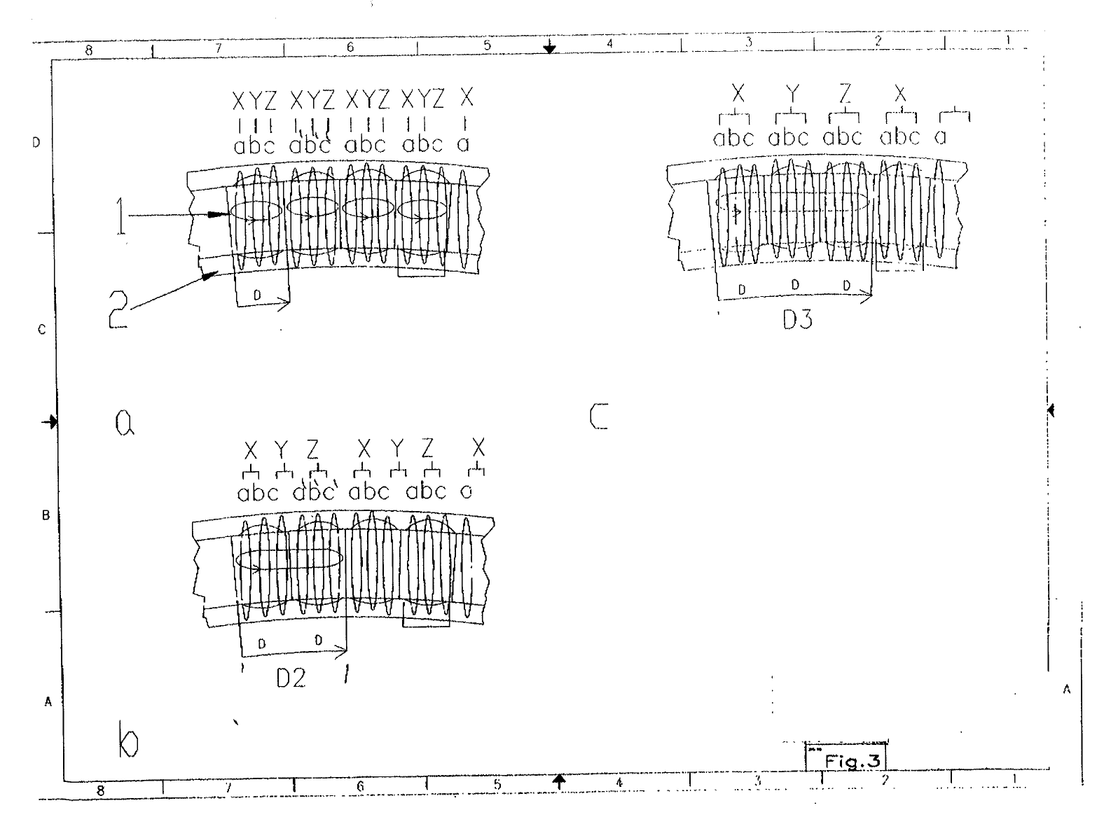

FIG. 3a is a schematic of the arrangement of FIG. 1b but having a one piece stator upon which is formed a plurality of slots for accommodating about the teeth between a plurality of coils. In particular coils a, b and c are energised by phases X, Y and Z respectively during one cycle of the three phase AC supply so as to provide the motive force to move the rotor a distance D1. Subsequently the next three coils a′, b′ and c′ are energised respectively by the phase X, Y and Z of the next cycle to move the rotor a further distance D1.

FIG. 3b depicts an arrangement whereby phase X energises coils a and b, while phase Y energises coils c and a′ and phase Z energises coils b′ and c′ to move the rotor a distance D2 during one cycle of the three-phase AC supply.

FIG. 3c depicts the coupling of coils a, b and c with phase X, a′, b′ and c′ with phase Y and a″, b″ and c″ with phase Z to move the rotor a distance D3 during one cycle of the three-phase AC supply.

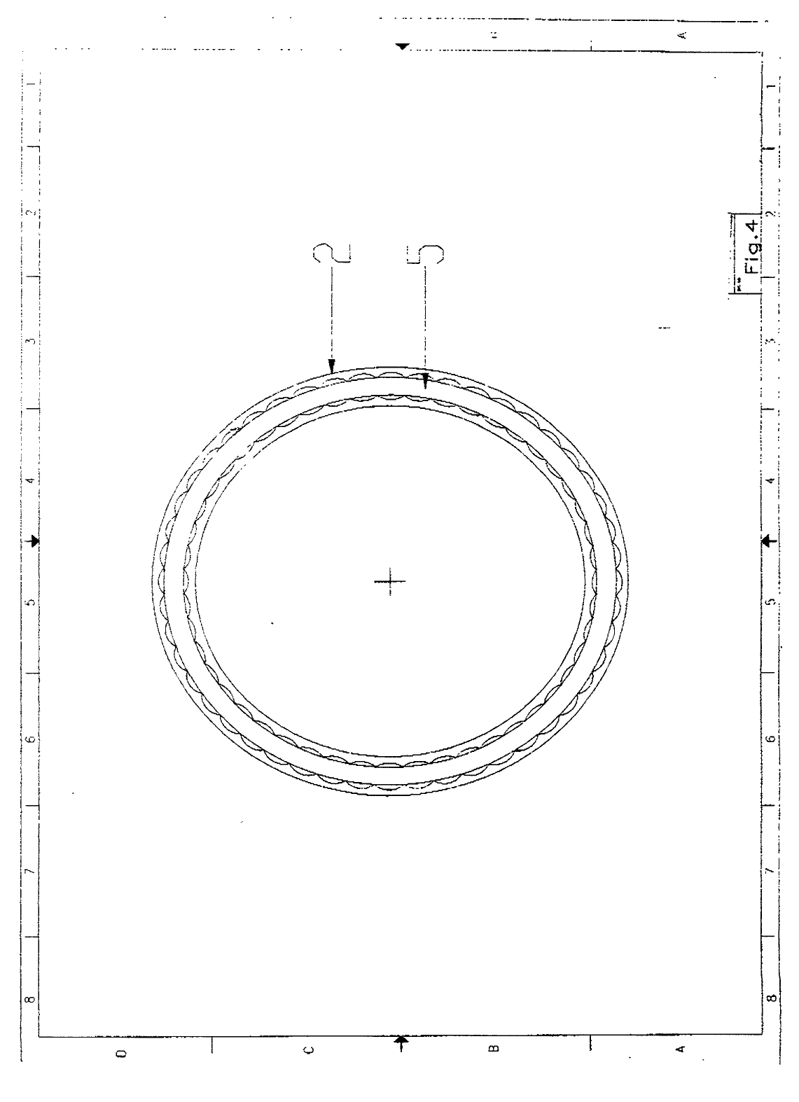

FIG. 4 depicts a schematic of a plurality of coils arranged on a single piece stator cut to have a plurality of slots and teeth to accommodate coils on each tooth spaced about the annular stator assembly.

Thickness and coil gauge will be variable and final dimensions will depend on both the current draw and torque requirements of the motor as can be calculated by one skilled in the art.

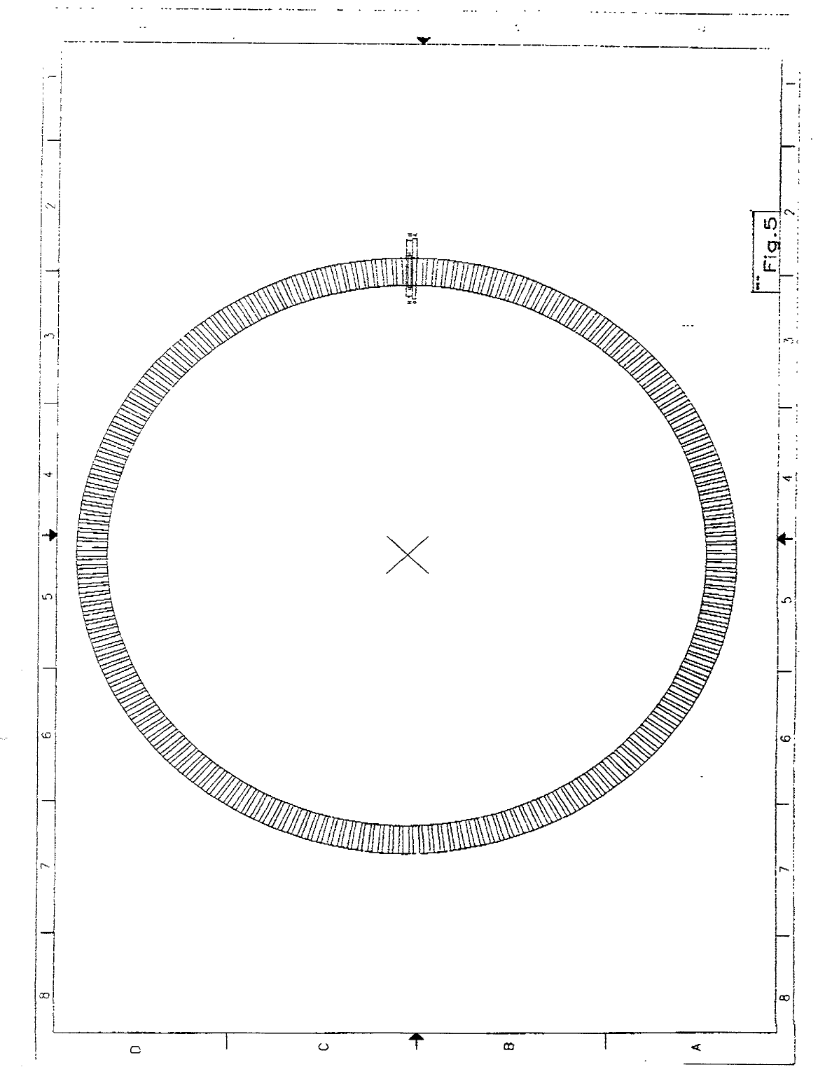

FIG. 5 depicts a side view of a continuous stator having wedge shaped slots where a<A which preferably form rectangular shaped teeth where h=H.

Upon such a stator is wound a corresponding array of individual coils having two ends. Each end is connected to a switching array of the like as discussed previously but not shown as the details can be readily determined by one skilled in the art.

It will be apparent that the adjacency of the stator and rotor in side to side relationship as depicted throughout this specification is merely illustrative and that it is possible for the arrangement to be otherwise, for example one above the other relative to the axis, etc.

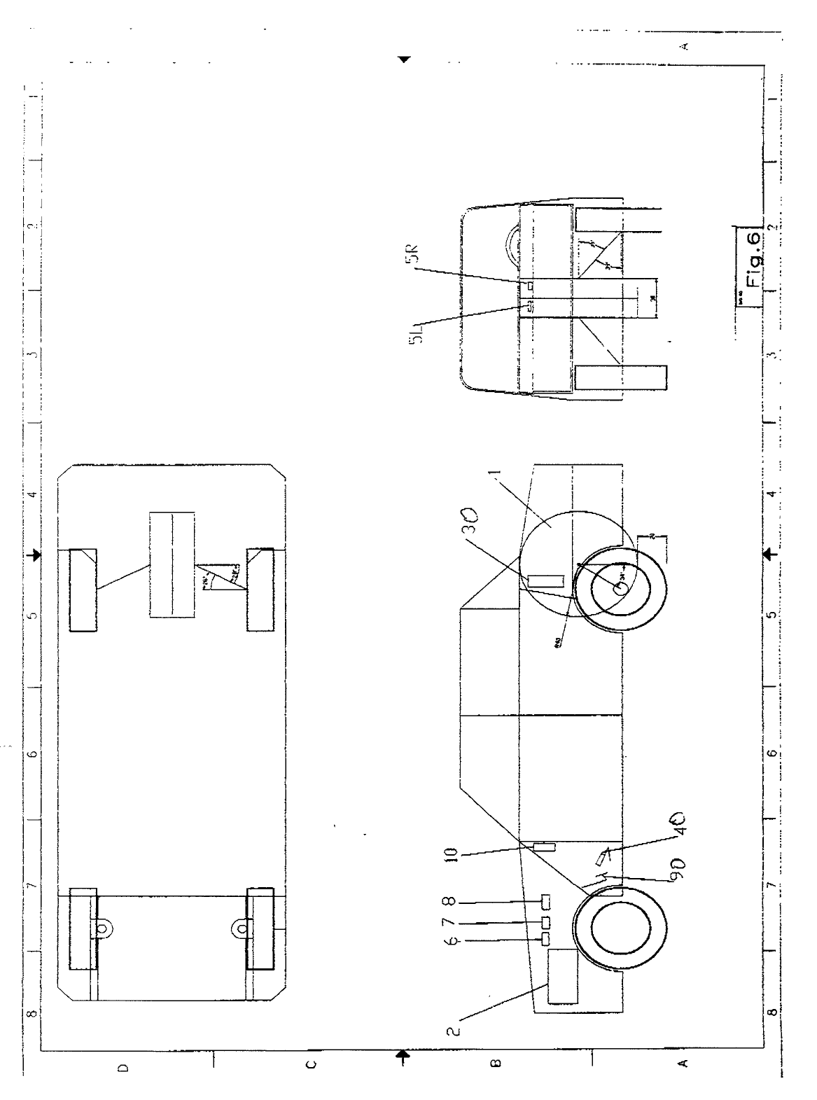

FIG. 6 depicts three views of a passenger vehicle modified to accommodate an electric motor according to the invention. In approximate terms a petrol internal combustion engine producing 180 Nm@2000 rpm will provide sufficient power to drive a passenger vehicle of modest dimensions.

It is an estimation of the inventor that an electric motor of the type depicted in FIGS. 1 to 5 having an outer diameter of approximately 800 mm would be sufficient to drive each rear wheel of the same passenger vehicle as described above.

Preferably, two electric motors are configured to couple respectively to rear wheels of the vehicle via a gearless universal joint arrangement. In this example the rotors and stators are orientated so that the output shaft of the motor is horizontal and due to the need to contain the motor body within the body of the vehicle, the height of the shaft is above the axis of rotation of the rear wheel, so two universal joints, one at the shaft and one at the wheel are used to transfer the rotation of the shaft to the axis of rotation of the wheel, as is best depicted in FIG. 6.

The two electric motors of the type described, require a means to control their respective speeds, which is provided by speed sensing elements SL and SR (L indicating the left hand side wheel and R indicating the right hand side wheel). A switching means and AC supply (30) is located near the left and right motors and the controller (10) for the switching and AC supply (30) is located preferably near the driver of the vehicle, as it is thus located close to the speed actuator (accelerator pedal) (40) and the brake pedal (90). A further element of the speed control means is an energy source, in this embodiment, including a means to convert stored DC energy into a single or multi (preferably 3) phase AC supply.

A yet further desirable element of the speed control means is a current demand gauge, an energy store gauge and a charging gauge.

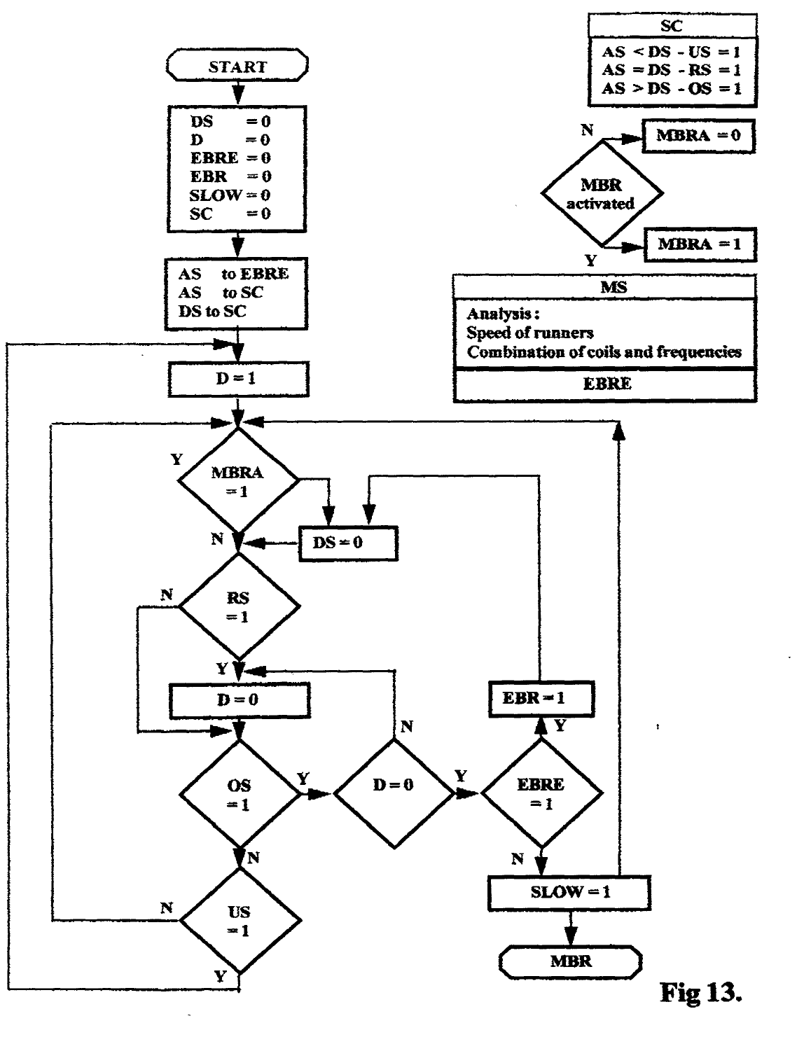

All of the abovementioned elements of the speed control means operate in a manner depicted in FIG. 13 which will be described later in the specification.

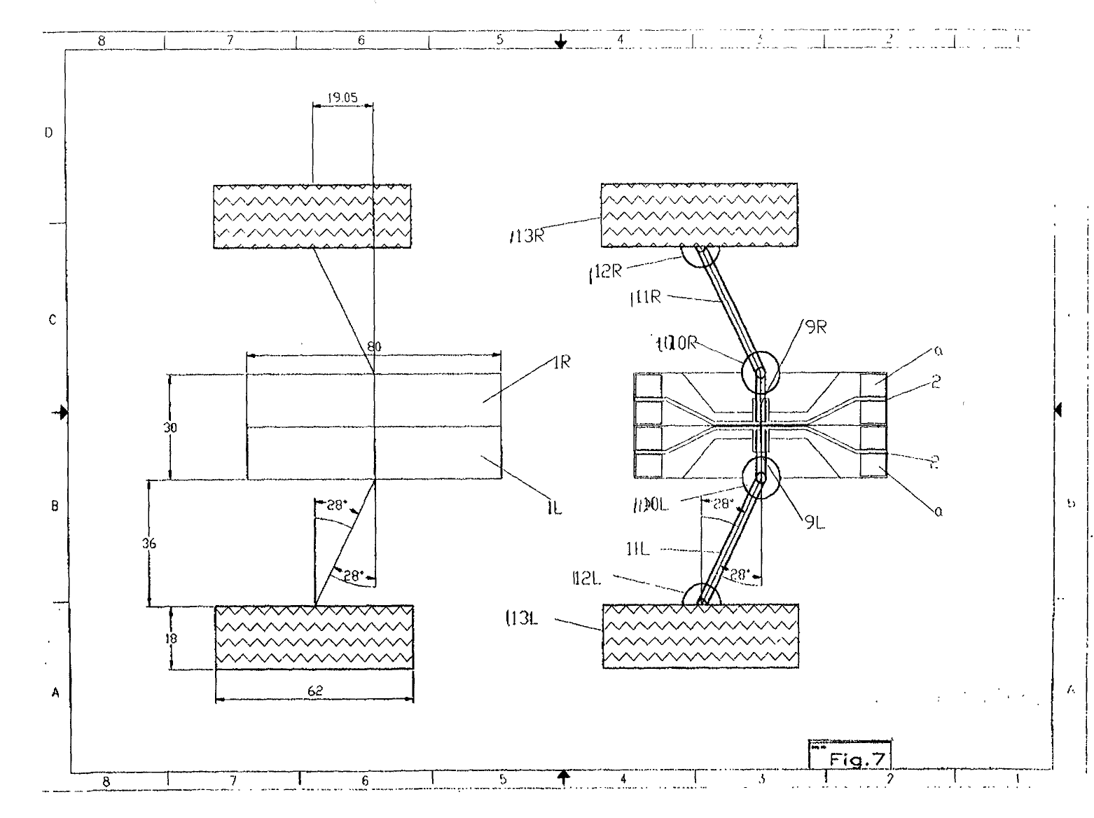

FIG. 7 depicts not only the universal joint arrangement but also a cross-section of the right and left hand electric motors showing the rotors (a) and the stator (52) with output shafts 9R and 9L coupled to respective ones of universal joint 100R or 100L. Transmission shafts 111R and 111L respectively connect 100R and 100L to second universal joints 112R and 112L which couple to the centre of rotation of the wheels 113R and 113L. The angles and dimensions on the figure are merely illustrative of a particular arrangement and should not limit the invention.

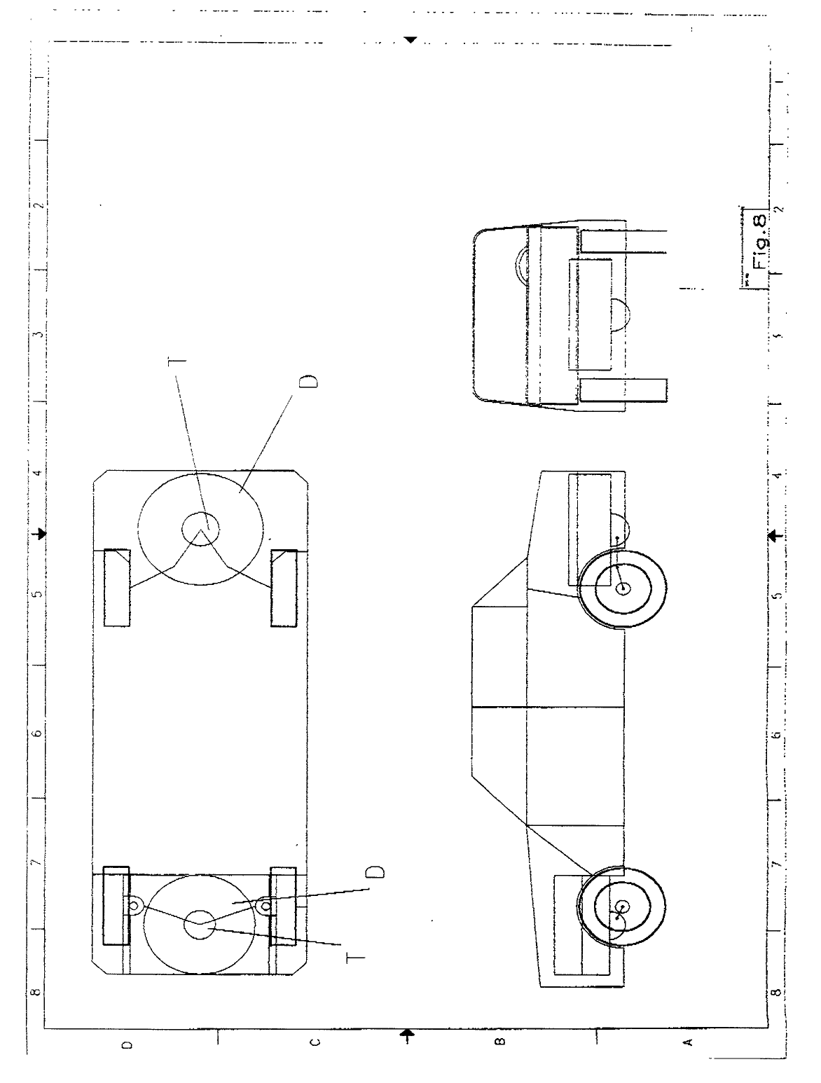

FIG. 8 depicts an arrangement where the motor is orientated so that the output shaft is vertical above and below the rotors of the motor and obviously appropriate universal joints are used to communicate the rotation of the rotors of the motors to respective left and right hand rear wheels of the vehicle.

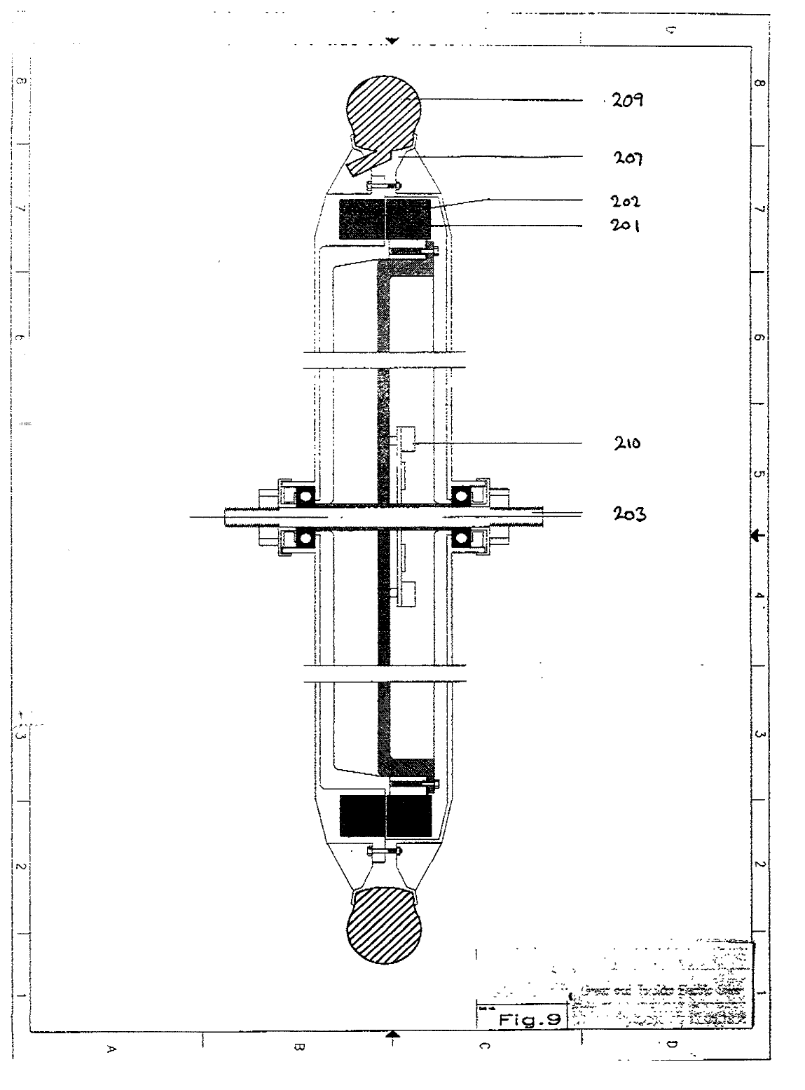

FIG. 9 depicts another application of the use of the invention in the sealed hub if a bicycle wheel or other driven wheel of a vehicle (eg a golf buggy, wheelchair etc). In this example the stator (201) of the motor is fixed to the hub (203) of the wheel and hence to the chassis of the vehicle, while the rotor (202) is connected to the rotatable rim (207) of the wheel which rotates on bearings journaled to the hub of the wheel.

The exact mechanical arrangement is not critical as the disclosure is directed to the ability of the motor to be configured in a wheel rather than located external of one and used merely to mechanically drive the wheel directly or indirectly with or preferably without gearing. Tyres (209) are filled to the rim (207). Since there is a seal for dust and moisture it is possible to house the switching means and speed control electronics (210) internal of the wheel housing, all that is required is a cable to conduct AC current supply to the selected coils of the stator in a manner previously described in respect of FIGS. 1 to 6.

FIG. 9 is a cross-section of the proposed wheel and only depicts the coil/stator and rotor elements end-on positioned at the top and bottom of the wheel but in accord with prior descriptions of an annular stator and rotor they in fact can extend about the full circumference of the wheel but are not shown as such in this figure.

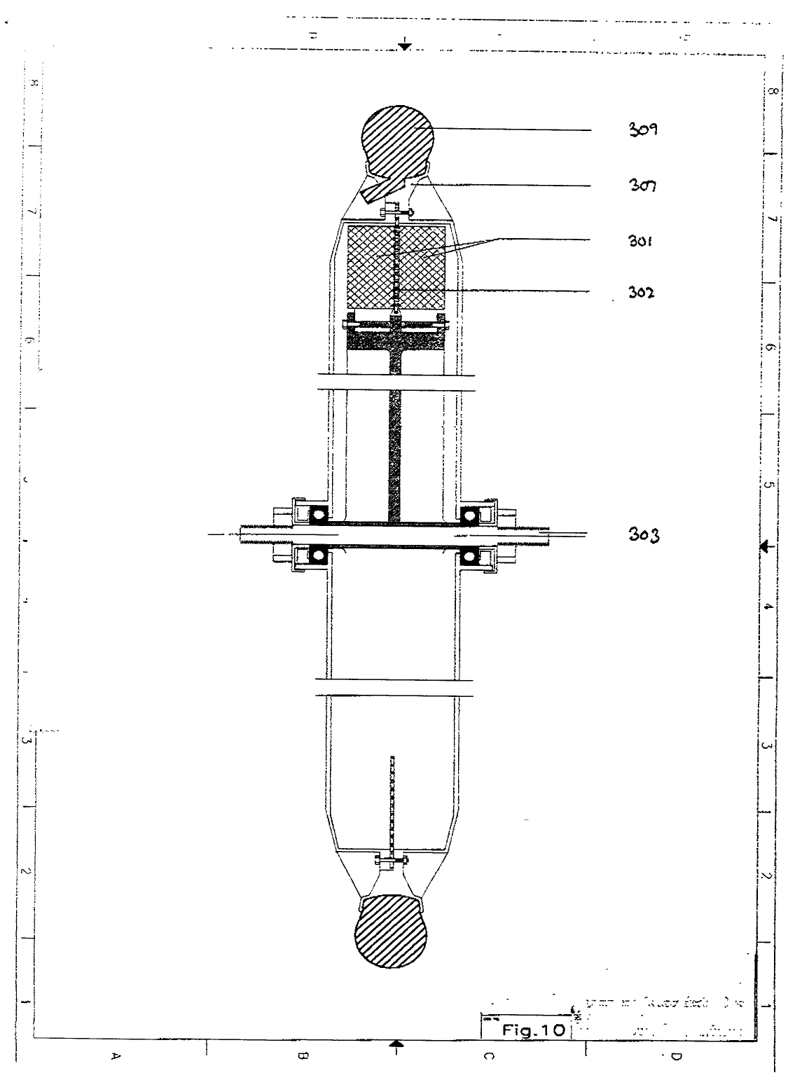

This arrangement is in contrast to that depicted in cross-sections in FIG. 10 which attempts to depict a cross-section of a stator (301) at the top of the wheel (307). The stator is shown extending only partially about the rim as well as on annular rotor (302) Furthermore, in this example there are two stators (301), located in close proximity with the rotor, referred to by the inventor as a double sided stator. When control electronics (not shown) energise the coils of the double sided stator the rotor is moved at a desired speed about its axis of rotation.

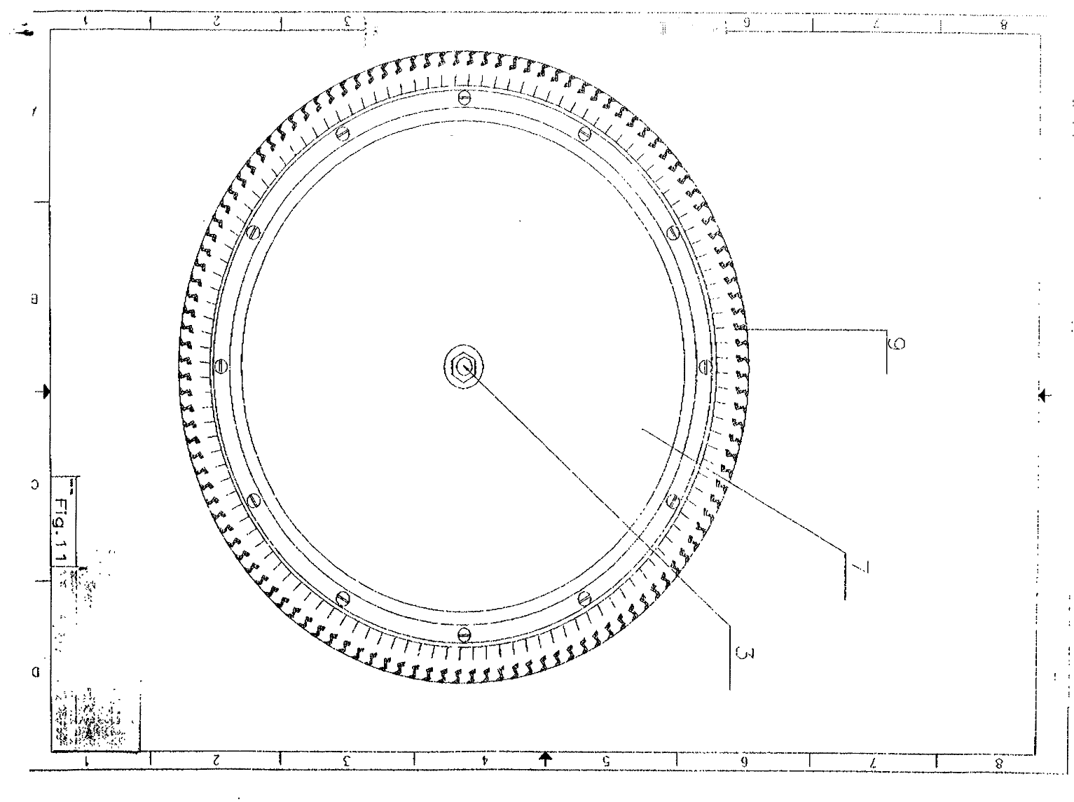

FIG. 11 is merely an external view of a sealed electric wheel of either of the types depicted in FIG. 9 or 10.

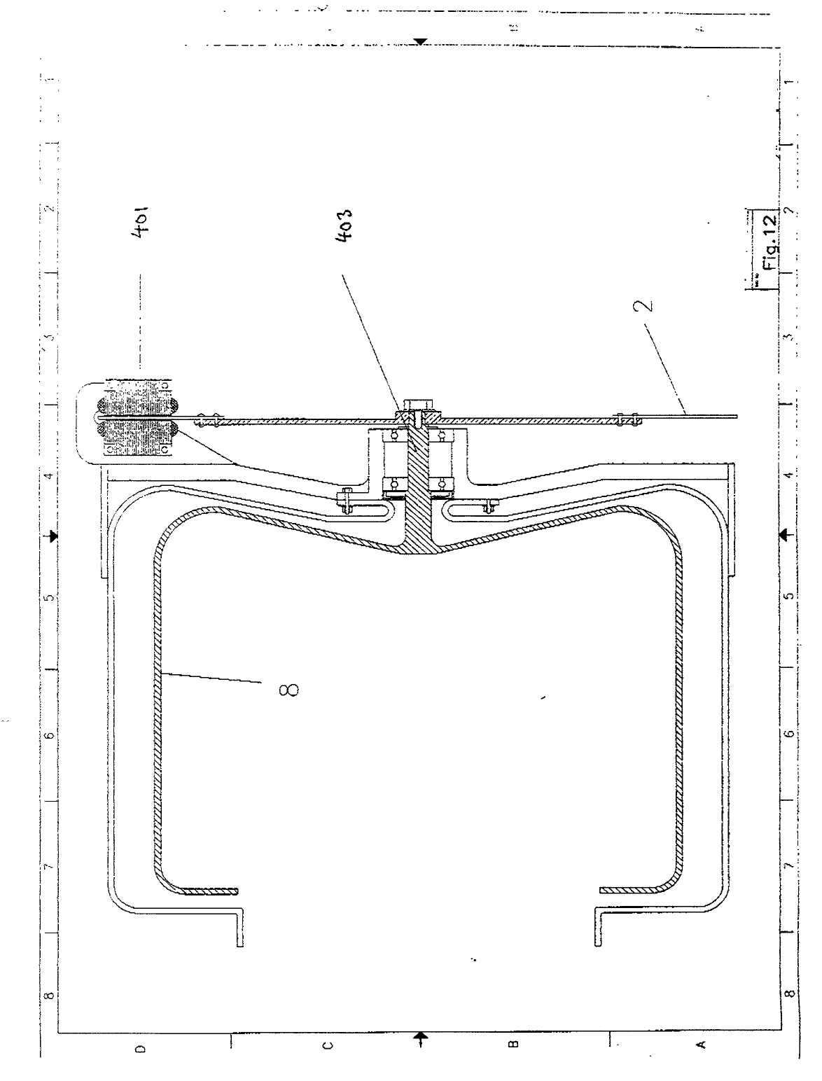

FIG. 12 depicts a schematic cross-sectional view of the internal configuration of a front loading washing machine. The stator (a doubled sided version) (401) is located so as to act upon an annular rotor (402) which is connected to an output shaft (403) which is directly coupled to the agitator (408) of the washing machine. Both the speed and direction of travel of the agitator can be controlled by the application of AC supply to the coils in the stator in a manner in accord with the invention as described previously.

Further mechanical details depicted in this and other figures are shown but not described herein as they are clearly not critical to the invention and are well within the skill of persons in the relevant field to replicate without the need for detailed description herein.

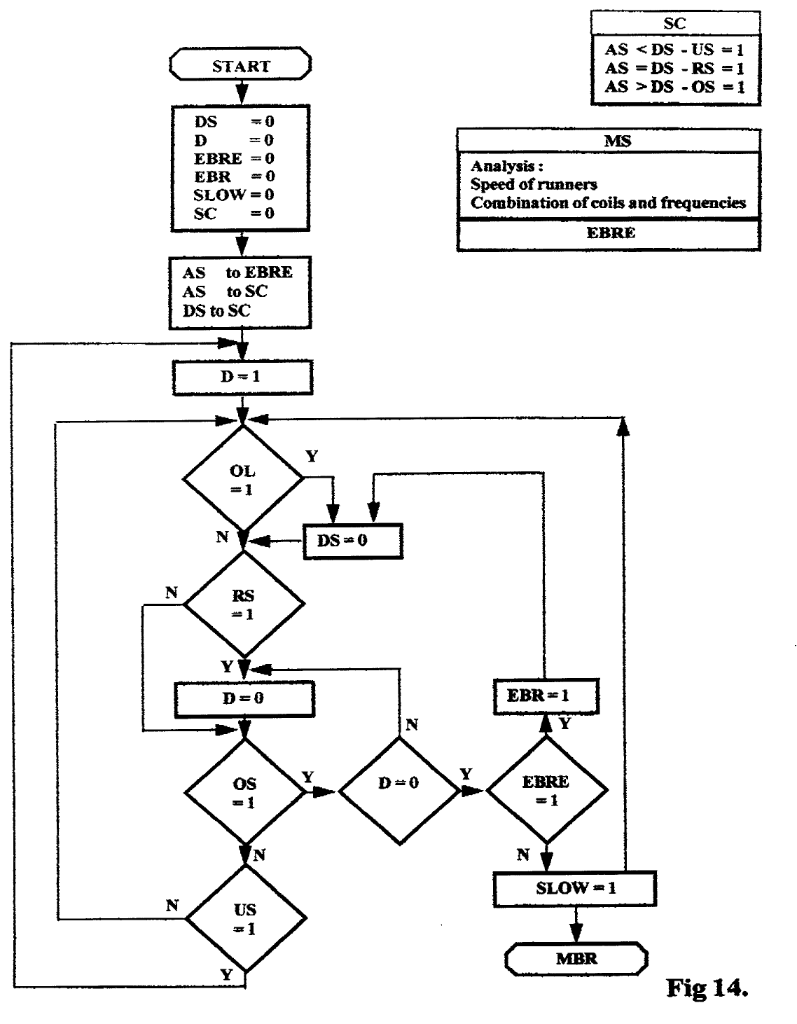

FIG. 13 shows a flow diagram of a speed controller for an electric motor as described above in relation to a motor vehicle as described herein and depicted schematically in FIGS. 6, 7 and 8. Symbols used in FIGS. 13 and 14 have the following meanings:

| | |
|---|---|
| 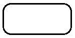 | event |
| 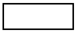 | event occurring |
| 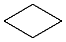 | check if event did occur |
| 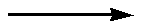 | direction of information flow |
| =1 | activated |
| =0 | deactivated |
| < | lower than |
| > | higher than |
| N | no |
| Y | yes |

Various signal nomenclature is as follows:

| | |
|---|---|
| AS | Actual speed (indicated by speed sensors L&R) |
| DS | Demand Speed (resultant speed after analysis of Energy |
| | storage unit and position of an accelerator) |
| EBR | Electric Brakes mode (switching stator of a drive from |
| | motor to generator mode) |
| EBRE | Electric Brakes mode Enable (if there is an appropriate |
| | precondition) |
| SLOW | indicator that mechanical brake should be in use |
| MBR | Mechanical Brakes Activation Sensor |
| MBRA | Mechanical Brakes (primary mechanical or parking brake) |
| MS | Mode Selector (analysis of speed of rotor, demand speed |
| | drives and available supply current to check possibility of |
| | switching to generator mode) |
| OS | OverSpeed of vehicle |
| US | UnderSpeed of vehicle |
| RS | Requested Speed |
| SC | Speed Comparator |
| OL | Overload protector operation |

The flow diagram of FIG. 14 can be described as follows:

As the control circuit is switched on by a start key or switch all the registers of tile Central controller are reset to 0.

The actual speed AS is sent to the Speed Comparator SC and because this is a starting procedure, the equation AS<DS is true so the US signal is set to 1.

The next step is to allow electrical energy to flow to the Power Electronics Circuit. This is activated by signal D=1. Being able to stop the vehicle at the driver's discretion is a most important aspect of any vehicle speed control system therefore. The system continually checks to determine whether the Mechanical Brakes are in use by the driver.

Furthermore, so as to increase the effectiveness of the braking process and secondly to protect electric circuits against overload it is not possible to drive the vehicle, and also have its brakes activated, thus it is necessary to continually check the actual speed and also check whether the mechanical brake has been actuated.

As the vehicle moves off from a standing start this process of acceleration means MBRA=0. The control system continually checks to determine whether RS has been reached. For illustrative purposes let us say it has not, then OS is still=0. Thus the vehicle is still accelerating, so the US signal=1 and system makes sure that D=1 and the checking loop is continually repeated.

At some point of time, after some number of loops SC will recognise that AS=DS so it will set RS=1. In this case, the control system will recognise that the Demanded Speed is reached so it will send a 0 signal to D and checks OS and US again.

At this time RS=1 so US=0 and the loop is closed at the point of checking the Mechanical Brakes actuation status. If the vehicle slows down, drives L&R Status US will equal 1 and D will =1 also and then loop repeats again.

Lets assume that SR was =1 at some stage, and the road has a downward slope. After checking for MBRA, SR will =0 with drive switched on, D=1 and the system will check OS. When OS=1 it means that the vehicle is travelling at a speed over the demanded speed. The next step is to check if drive is still on D=1 and if it so, makes D=0 then again checks to determine if the speed has reduced. If not, EBRE is checked and there is a possibility of a mode change. If the vehicle is still travelling above the desired speed and EBRE=1 and the mode changed by sending signal EBR=1, Electric Brakes are activated ON and the process of deceleration begins.

While the vehicle is not expending energy to maintain a desired speed, it is possible to use the kinetic energy of the vehicle and the motion imparted to the motor parts to use the motor as a generator of electric energy which can then be stored in the storage unit.

The amount of energy recuperated depends on the amount of braking action or the amount of downhill driving where no expenditure of energy is required.

The mechanical braking system is deactivated as is the Demanded Speed value changed to DS=0. Once the vehicle is slowed by the regeneration mode to a predetermined point the value of SLOW=1 is activated indicating that the electrical braking process has stopped and mechanical braking has or can commence.

Normal ABS techniques can be used so that adequate braking pressure can be applied to the mechanical brakes in a way such that the change over to a mechanical braking mechanism will be difficult to detect by the driver until full mechanical engagement is being used. However a normal mechanical braking arrangement is necessary, in case there is electrical failure. It follows that the mechanical braking system will be fully engaged when part of or all of the electrical system is de-energised (eg no START signal is generated).

FIG. 14 shows a flow diagram of a speed controller for use in an electric bicycle having an electric motor described above and illustrated in FIGS. 9 to 11. Maximum speed may be set according to the requirements of local laws.

Symbols used in this Figure have the same meanings as those described for FIG. 13.

Various signal nomenclature used in FIG. 14 is as follows:

| | |
|---|---|
| AS | Actual speed (indicated by speed sensors) |
| DS | Demand Speed (resultant speed after analysis of Energy storage |
| | unit and position of an accelerator) |
| EBR | Electric Brakes mode (switching stator of a drive from motor to |
| | generator mode) |
| EBRE | Electric Brakes mode Enable (if there is an appropriate |
| | pre-condition) |
| SLOW | indicator that mechanical brake should be in use |
| OS | OverSpeed of vehicle (greater than demanded speed or |
| | Maximum allowable speed as dictated by law) |
| US | UnderSpeed of vehicle |
| RS | Requested Speed |
| SC | Speed Comparator |
| MS | Mode Selector (analysis of speed of rotor runners of drives and |
| | available frequencies to check possibility of switching to |
| | generator mode) |

This flow diagram can be described as follows as being the same as that for FIG. 13, except for the function of an OverLoad Protection which replaces the MBRA Mechanical Brake function of the motor vehicle example illustrated by FIG. 13.

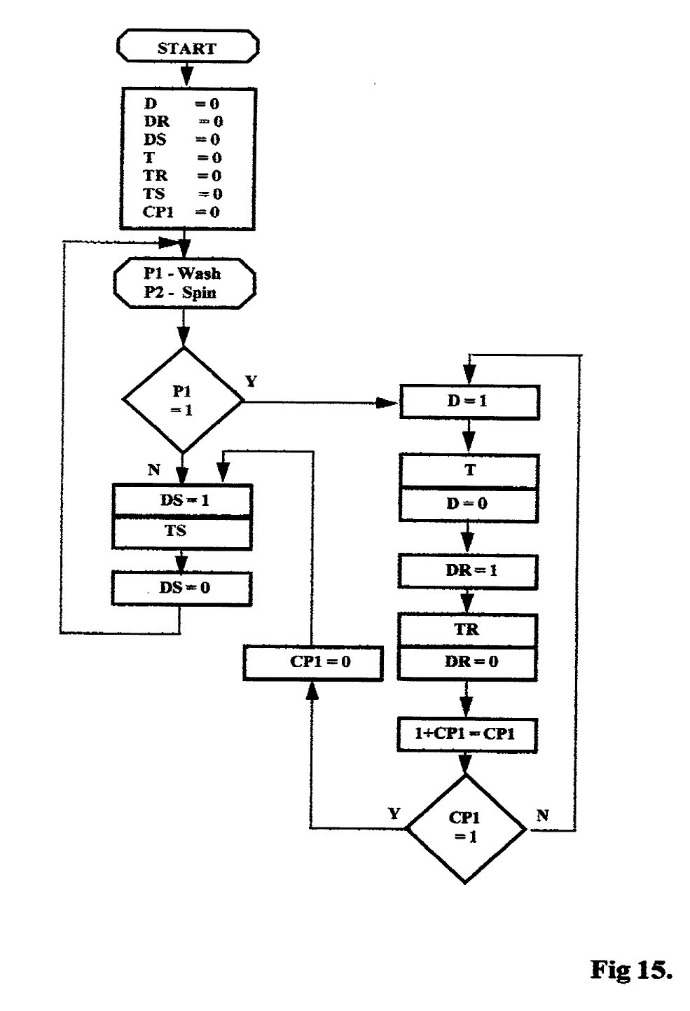

FIG. 15 shows a flow diagram of a speed controller for a washing machine as described herein and schematically depicted in FIG. 12.

Various signal nomenclature is as follows:

| | |
|---|---|
| D | clockwise rotation with respect to the front of the appliance of an |
| | internal drum |
| DS | spin rotation of an internal drum |
| DR | reverse rotation of an internal drum |
| LC | loop counter (different for different programs) |
| T | timing of forward rotation |
| TS | timing of spin rotation |
| TR | timing of reverse rotation |
| CP1 | loop counter for program 1 |
| P1 | program 1 - washing |
| PS | program 2 - spinning |

The flow diagram of FIG. 15 can be described as follows:

A start signal is generated once the appliance is switched “on” which causes all the registers D, DR, DS, T, TR, TS and CP1 to be set to a “0” value or cleared. The system then checks to determine whether the user has selected program P1 for WASH or P2 for SPIN only. If the program selected is WASH the motor drive is energised by the D=0 signal and the internal drum is rotated in one direction for a time T and power to the motor is removed by the signal D=0. Power is again applied to the motor but so that it rotates in an opposite direction to that previously provided for a time TR, after which power to the motor is removed by the signal D=0. So as to repeat the above cycle a number of times such that an adequate agitation is imparted the clothes in the washing machine, a cycle counter register CP1 is decremented after each cycle and once the cycle count equals a predetermined count say 0 when CP1=0 the controller initiates a spin rotation by setting DS=1.

A timer is begun and spin action of the internal drum continues until the count is complete (which may be a countdown to zero or a count up to a predetermined (possibly user set) value).

Once the time units have lapsed the spin cycle is completed and DS signal is set 0 and the complete wash and spin cycle is complete.

Clearly, the functions described above in relation to FIGS. 13, 14 and 15 are a minimal set of functions and more complicated processes are easily implemented by the designer and programmer.

It will be appreciated by those skilled in the art, that the invention is not restricted in its use to the particular application described and neither is the present invention restricted in its preferred embodiment with regard to the particular elements and/or features described or depicted herein. It will be appreciated that various modifications can be made without departing from the principles of the invention, therefore, the invention should be understood to include all such modifications within its scope.

I claim:

1. An electric motor comprising:
a frame or housing around an output shaft,
electronically energisable drive means carried by one of the frame or housing and said shaft, and
driven means carried by the other of the housing and the shaft, wherein the drive means and driven means have co-operating adjacent faces extending radially of the shaft axis, characterised in that the drive means comprises one or more linear electric motors equally radially spaced from the shaft axis and electrically energised so as to effect relative rotation between the frame or housing and the shaft at a predetermined rotational velocity about the shaft axis in a predetermined direction.

2. An electric motor according to claim 1 wherein sets of linear electric motors are electrically energised by a single-phase or a multi-phase alternating electric current so as to effect relative rotation of the frame or housing about the shaft axis at a speed determined by the frequency of said alternating current.

3. An electric motor according to claim 1 wherein one or more sets of linear electric motors are each electrically energised by one of a multi-phase alternating electric current so as to effect relative rotation of the frame or housing about the shaft axis at a speed determined by the number of sets of linear electric motors energised by a respective phase of the multi-phase alternating electric current, wherein the frequency of said alternating current is constant.

4. An electric motor according to claim 1 wherein a first set of two or more adjacent linear electric motors are energised by a first phase of a three-phase alternating electric current; and a second set of two or more linear electric motors adjacent to said first set are energised by a second phase of a three-phase alternating electric current; and a third set of two or more linear electric motors adjacent to said first and second set are energised by a third phase of a three-phase alternating electric current so as to effect relative rotation of the frame or housing about said shaft axis at a speed determined by the number of adjacent linear motors energised by a respective phase of a three-phase alternating electric current wherein the frequency of said alternating current is constant.

5. An electric motor according to claim 1 wherein said frame or housing is of annular shape with the shaft formed with or attached to the driven means, so as to function as an output or drive shaft, wherein said driven means is carried by the shaft and comprises an annular ring of electromagnetic or electrically conductive material located on the circumference of a disc upon which, at the radial centre, is located said shaft.

6. An electric motor according to claim 1 wherein said drive means comprises a plurality of annular stator windings carried by said frame or housing wherein each said winding is arranged equally radially spaced from said shaft axis adjacent each other forming a continuous circumferential array of coils aligned and adjacent to the annularly shaped material of said driven means.

7. An electric motor according to claim 1 wherein said energisation of sets of one or more adjacent coils is by a respective phase of a three-phase alternating current supply.

8. An electric motor according to claim 1 wherein the speed of rotation of said shaft of said electric motor is controlled by energising a predetermined number of adjacent coils being less than, equal to, or more than a previous number of coils while also energising respective sets of one or more coils equally circumferentially spaced about an annular ring of electromagnetic or electrically conductive material.

9. An electric motor according to claim 1 wherein said driven means comprises coils wound upon amorphous magnetic material.
